(19) United States
(12) Patent Application Publication
(10) Pub. No.: US 2021/0288599 A1
(43) Pub. Date: Sep. 16, 2021

(54) Off-grid power generating system for supplying an external load

(71) Applicant: Enerdrive Limited, Hong Kong (CN)

(72) Inventors: Ezio Bertotto, Vicenza (IT); Antonio Prearo, Vicenza (IT); Roberto Lotto, Vicenza (IT)

(21) Appl. No.: 16/336,856

(22) PCT Filed: Sep. 28, 2017
(86) PCT No.: PCT/IB2017/055966

§ 371 Date: Mar. 26, 2019

(30) Foreign Application Priority Data
Sep. 28, 2016 (IT) 102016000096849

(51) Int. Cl. H02P 9/10; H02P 9/02

(52) U.S. Cl. CPC H02P 9/10; H02P 9/02

(57) ABSTRACT

An off-grid system for generating electrical energy for feeding an external load includes at least one electric generator operatively connected to a driven shaft of an external driving power source and further connected to an isolated load by an electrical circuit, a control unit connected to the electrical circuit to detect the output voltage produced by the generator, and a fluxation regulation system connected to the electrical circuit to control the fluxation and stabilize the voltage produced by the generator. The control unit is connected to the fluxation regulation system to control the activation thereof and the generator is of the reluctance synchronous type and includes a squirrel cage structure. A method for controlling the fluxation of electrical energy by the electrical energy generation system.

### TECHNICAL FIELD OF THE INVENTION

The present invention generally applies to the technical field of electric machines and in particular it regards an off-grid system for generating electrical energy for feeding an external load.

The invention also regards a method for controlling the fluxation of the energy produced by the aforementioned generation system.

### STATE OF THE ART

Electric machines of the generator type comprising a stator and a rotor coupled to a driven shaft driven in rotation by an external driving power source, for example of the mechanical, wind energy and hydraulic type have long been known.

Typically, electric generators of considerable power are of the asynchronous type, wound field synchronous type or of the type with permanent magnets.

Asynchronous generators reveal the drawback of having considerable electrical losses that reduce the efficiency thereof, while permanent magnet generators are particularly expensive and require complex and over-dimensioned control means. Reluctance synchronous generators comprising a stator and a transversal lamination rotor made up by a plurality of laminar elements gathered into a pack was designed in order to at least partly overcome such drawbacks.

The laminar elements of the rotor have extended and curved-shaped cavities, closed at the ends and defining, in the peripheral portion of each laminar element, ribs for saturating the electromagnetic field.

Document 102016000027721, owned by the applicant, discloses a reluctance synchronous generator comprising a squirrel cage structure associated to the rotor and connected to the system for supplying the produced electrical energy.

In particular, the squirrel cage comprises a plurality of longitudinal conductor elements peripherally distributed with respect to the pack of laminar elements and connected by means of respective short-circuiting rings integrally joined to the rotor and arranged at the ends thereof.

Such configuration enables reducing any torque oscillations on the generator and producing frequency electrical energy and constant voltage, with respect to the reluctance synchronous generators described above.

However, a first drawback of such solution lies in the fact that such generator should not be used in an off-grid system, i.e. a system in which the generator is connected to an isolated load of the power supply mains.

As a matter of fact, the generator described above has an operating nominal voltage below the reference voltage value, i.e. the optimal operating voltage, following connection with the load.

A further drawback lies in the fact that the connection of a load with reactive component to the generator could cause a reduction of the power factor and an ensuing further reduction of the voltage at the heads of the generator.

Furthermore, a further drawback lies in the possible presence of harmonics produced by the connection with the isolated load.

### OBJECTS OF THE INVENTION

In view of the prior art, the technical problem to be overcome lies in increasing the operating nominal voltage in a reluctance synchronous electric generator used in an off-grid system by means of fluxation with compensation of the reactive power.

An object of the present invention is to solve the aforementioned technical problem overcoming the drawbacks outlined above, by means of an off-grid system for generating electrical energy for feeding an external load that is highly efficient and relatively inexpensive.

A particular object of the present invention is to provide an electrical energy generation system of the type described above capable of enabling maintaining the voltage generated during operation at a value proximal to the optimal operating voltage.

A further object of the present invention is to provide an electrical energy generation system of the type described above capable of enabling obtaining a power factor the closest possible to 1.

Another object of the present invention is to provide an electrical energy generation system of the type described above, capable of efficiently reducing the harmonic distortion.

A further object of the present invention is to provide an electrical energy generation system of the type described above comprising a software for controlling the fluxation of an off-grid reluctance synchronous electric generator. These and other objects which will be more apparent hereinafter, are attained by an off-grid electrical power generation system for feeding an external load according to claim 1, comprising at least one electric generator actuated by an external driving power source and connected to a load by means of an electrical circuit, a control unit connected to the circuit to detect the output voltage produced by the generator and fluxation regulation means connected to the electrical circuit to control and stabilise the voltage produced by the generator.

The control unit is connected to fluxation means for controlling the activation thereof and the generator is of the reluctance synchronous type and comprises a squirrel cage.

According to a further aspect of the invention, a method is provided for controlling the fluxation of electrical energy produced by the aforementioned generation system, according to claim 11.

Advantageous embodiments of the invention are defined according to the dependent claims.

### BRIEF DESCRIPTION OF THE DRAWINGS

Further characteristics and advantages of the invention will be more apparent in view of the detailed description of some preferred but non-exclusive embodiments of an off-grid system for generating electrical energy for feeding an external load according to the invention, illustrated by way of non-limiting example with reference to the following drawings, wherein:

FIG. 1 is a simplified schematic view of the off-grid system for generating electrical energy for feeding a load subject of the invention;

FIG. 2 is a view of the scheme for controlling the fluxation means of the system according to the invention;

FIG. 3 is a perspective view of the reluctance synchronous generator of the system of FIG. 1;

FIG. 4 is a front view of a first detail of the reluctance synchronous generator of FIG. 2;

FIGS. 5A and 5B represent two diagrams indicating the trend of the voltage produced by the generator with respect to the frequency in absence or in presence of fluxation means.

### EMBODIMENTS OF THE INVENTION

With reference to the mentioned figures, an off-grid system is illustrated, generally indicated with reference number 1, for generating electrical energy for feeding an external load C.

The isolated load C may be constituted by any machine which requires electrical current for the operation thereof and the system 1 is connected to an external driving power source S having a predetermined drive torque.

In particular, the system 1 may be applied to systems for producing electrical energy starting from renewable energy sources, such as for example wind or water energy and the drive source S may be a water turbine.

It is clear that a water turbine may be replaced by a wind or vapour turbine, or a fossil fuel internal combustion engine, without departing from the scope of protection of the invention.

In a preferred embodiment of the invention, the system 1 comprises at least one electric generator 2 operatively connected to a driven shaft 3 of the driving power source S and connected to an isolated load C by means of an electrical circuit 4. The generator 2 may be of the type described in the patent application number 102016000027721, on behalf of the applicant, i.e. a reluctance synchronous generator.

In particular, the generator 2 may comprise a stator 5 provided with a plurality of poles and corresponding grooves 6 in a predetermined number and a rotor 7 formed by a plurality of laminar elements 8 gathered in a pack 8′ and integrally joined to the driven shaft 3.

Each laminar element 8 comprises a plurality of adjacent cavities 9 and a central through hole 10 so as to be inserted onto the driven shaft 3 without clearance. Furthermore, the cavities 9 are in a number corresponding to the number of grooves 6 of the stator 5 and they may have a substantially circle arc shape extended base.

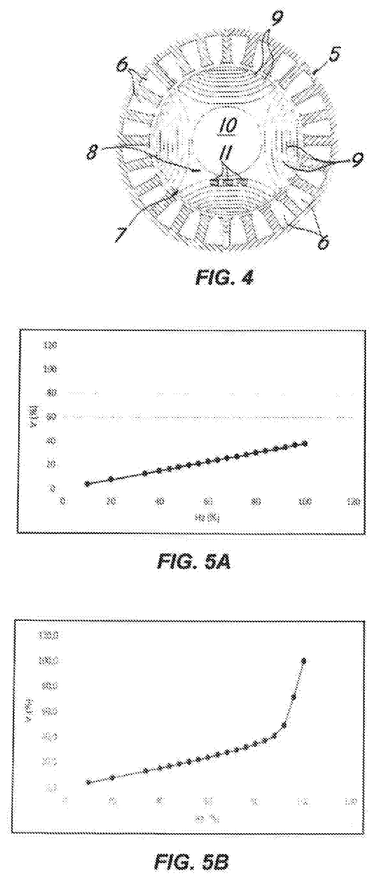

In a preferred embodiment of the invention, illustrated in FIG. 4, the generator 2 may comprise at least one permanent magnet 11 inserted into the corresponding cavities 9 or in all cavities 9 of the laminar elements 8.

Advantageously, as illustrated in FIG. 3, the generator 2 comprises a squirrel cage structure 12 associated to the rotor 7 and having a plurality of axial conductor elements 13 peripherally distributed with respect to the pack 8′ of laminar elements 8.

The conductor elements 13 may be connected by means of respective short-circuiting rings 14 integrally joined to the rotor 7 and arranged at the longitudinal ends thereof.

Furthermore, the conductor elements 13 may be present in a number proportional to the number of poles of the rotor 7 and they be inserted into the cavities 9 in proximity of the peripheral edge of each laminar element 8.

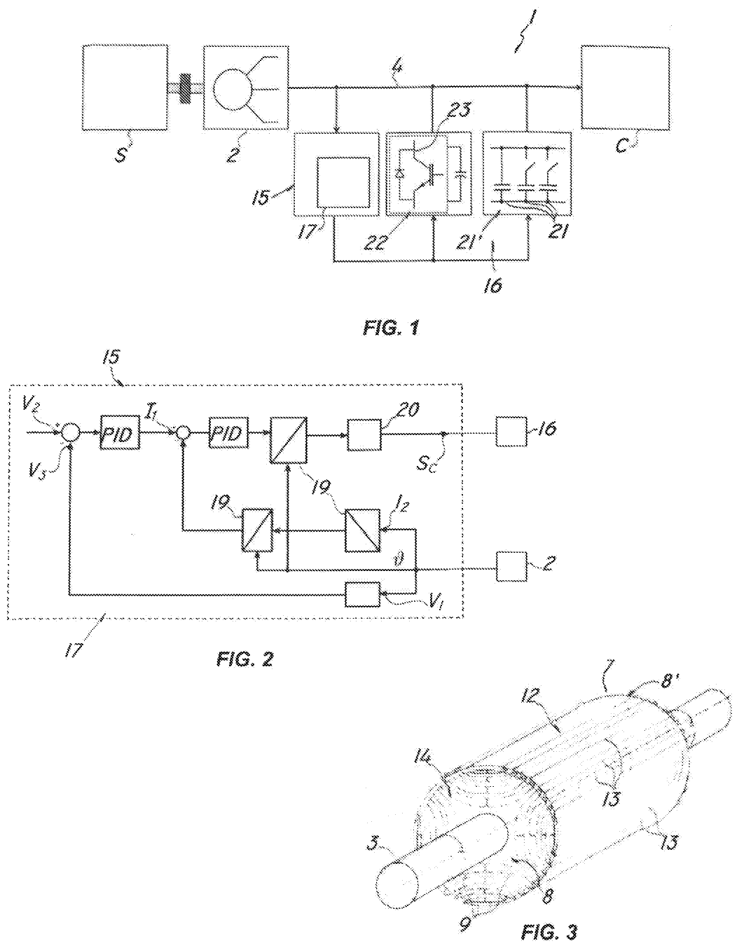

As illustrated in FIG. 1, the system 1 further comprises a control unit 15 connected to the electrical circuit 4 to detect the voltage to the ends of the generator 2 and fluxation regulation means 16 connected to the electrical circuit 4 for controlling the fluxation and stabilise the voltage produced by the generator 2. The control unit 15 is further connected to the fluxation regulation means 16 to selectively activate them when the voltage V₁ produced by the generator 2 and detected by the control unit 15 is lower than the optimal operating voltage V₂.

For example, the latter is equivalent to 380V at a frequency value of 50 Hz and in absence of suitable fluxation regulation means 16 the produced voltage is much lower with respect to this value, as illustrated in the diagram of FIG. 5A.

In the system 1 subject of the present invention, the generated voltage V₁ may be maintained at a value proximal to the optimal operating voltage V₂ and the reactive power required by the load C will be compensated when connecting the generator 2, as illustrated in the diagram of FIG. 5B.

The control unit 15 comprises a logic sub-unit 17 on which a suitable software is installed together with a two-ring control algorithm with PID control and a first sub-unit 18 for converting the detected voltage V₁ into an effective value V₃ for comparison thereof with the optimal operating voltage V₂, illustrated in FIG. 2. The software, as function of the difference between the effective value V₃ of the generated voltage V₁ and that of the optimal operating voltage V₂ adjusts the reference current amplitude I₁, which represents the capacitive current amplitude which is to be injected by the fluxation means 16 into the circuit 4.

The innermost ring of the software will compare the reference current I₁ with the detected current I₂ suitably transformed into a synchronous quantity by a second conversion sub-unit 19 which uses the angular position of the rotor ϑ.

The result of the adjustment is processed by an algorithm SVM 20 for generating a suitable activation signal Sc intended for the fluxation regulation means 16.

The sending of the activation signal to the fluxation means 16 will guarantee the dispensing of a synchronous current with the electrical quantities of the generator 2 and with suitable module and phase values to carry out voltage compensation. The fluxation regulation means 16 may comprise at least one capacitor 21 or, alternatively, one or more batteries 21′ for capacitors 21 connected—in parallel fashion—to each other and with respect to the load C, in presence of one or more reluctance synchronous generators 2.

In a per se known manner, capacitors 21 may be selected from among the group comprising static and electromechanical switches and they enable obtaining an improvement of the power factor, or a reactive power compensation required by the load C following the connection thereof with the generator 2.

In the embodiment schematically illustrated in FIG. 1, the fluxation regulation means 16 comprise, besides the batteries 21′ of the capacitors 21, an active voltage compensator circuit 22 connected—in parallel fashion—with respect to the capacitors 21 and having an inverter PWM 23.

Advantageously, both the compensator circuit 22 and the capacitors 21 may be directly fed by the reluctance synchronous generator 2 and they may be selectively activated by the software of the control unit 15, as described above. Furthermore, the fluxation regulation means 16 may enable reducing any harmonic distortion produced by the load C.

According to a further aspect of the invention, a method is provided for controlling the fluxation of the electrical energy produced by the generation system 1, described above.

The method comprises a step a) for empty activating the synchronous generator 2 actuated by the driving source S and a step b) for detection by the control unit 15 of the voltage V₁ output by the generator 2 and comparison of the latter with the optimal operating voltage V₂.

Subsequently, a step c) is provided for activating the batteries 21′ of the capacitors 21 by the control unit 15 to bring and maintain the voltage V₁ output by the generator 2 at/to a value proximal to the optimal operating voltage V₂. Advantageously, the output voltage V₁ may correspond to about 80% of the overall optimal voltage.

Subsequently, provision is made for a step d) for electrical connection between the generator 2 and the isolated load C and a step e) for detecting the current output by said generator 2 for comparing the same with 1 the optimal operating voltage V₂ by the control unit 15.

Should the output voltage V₁ be lower than the optimal one, the control unit 15, during step f), activates the voltage compensator 22 and the latter fluxes the capacitive current into the circuit 4 during step g), so as to compensate the reactive power required by the connected load C.

Thus, the amount of initial capacitive current to be fluxed will be the one required by the synchronous generator 2 while the further capacitive current will be the one required by the load C following connection thereof.

The latter can be adjusted by the compensator circuit 22 to maintain the voltage of the system 1 at a value proximal to the optimal operating voltage.

Even though the off-grid electrical energy generation system has been described with particular reference to the attached figures, the reference numbers have been used to improve the intelligibility of the invention and shall not be deemed to limit the scope of protection subject of the claims.

The present invention can be applicable at industrial level in that it can be produced in an industrial scale by industries belonging to the field of electric machines used in off-grid systems.

The off-grid electrical energy generation system described above can be subjected to numerous modifications and variants falling within the scope of protection of the claims that follow.

The invention claimed is:

1. An off-grid system (1) for generating electric energy and feeding an external load (C), said off-grid system (1) comprises:
at least one electric generator (2) operatively connected to a driven shaft (3) of an outer power source (S) and connected to an isolated load (C) by an electric circuit (4);
a control unit (15) connected to said electric circuit (4) for detecting outgoing tension produced by said generator (2);
wherein regulating means are provided (16), which are connected to said electric circuit (4) to control fluxation and stabilize tension produced by said generator (2);
wherein said control unit (15) is connected to said regulating means (16) to control their selective activation; and
wherein said generator (2) is a synchronous reluctance generator and comprise a squirrel cage structure (12).

2. The off-grid system according to claim 1, wherein said fluxation regulation means (16) comprise at least one capacitor (21).

3. The off-grid system according to claim 2, wherein said fluxation regulation regulating means (16) comprise one or more arrays (2) of capacitors (21) positioned in parallel therebetween and with the isolated load (C).

4. The off-grid system according to claim 3, wherein said capacitors (21) are chosen from the group consisting of static or electromechanical switches.

5. The off-grid system according to claim 3, wherein regulating means (16) comprises an active tension compensator circuit (22) in parallel with said arrays (2) of capacitors (21).

6. The off-grid system according to claim 5, wherein said tension compensator circuit (22) and said arrays (2) of capacitors (21) are directly fed by said synchronous reluctance generator (2).

7. The off-grid system according to claim 5, wherein said compensator circuit (22) comprises a PWM inverter (23).

8. The off-grid system according to claim 5, wherein said control unit (15) comprises a logic sub-unit (17), on which a control software and a two-ring control algorithm are installed.

9. The off-grid system according to claim 8, wherein said control software is configured for selectively activating fluxation by said arrays (2) of capacitors (21) and/or by said tension compensator circuit (22) to maintain a generated tension (Vi) at a value proximate an optimum working tension (V2) and compensate a reactive power demanded by the isolated load (C).

10. The off-grid system according to claim 1, wherein the off-grid system is adapted for use in hydraulic turbines.

11. A method for controlling fluxing of electric energy produced by a system (1) at least one electric generator (2) operatively connected to a driven shaft (3) of an outer power source (S) and connected to an isolated load (C) by an electric circuit (4);
a control unit (15) connected to said electric circuit (4) for detecting outgoing tension produced by said generator (2);
wherein regulating means (16) are provided, which are connected to said electric circuit (4) to control fluxation and stabilize tension produced by said generator (2), the regulating means comprising one or more arrays (2) of capacitors (21) positioned in parallel therebetween and with the load (C), and an active tension compensator circuit (22) in parallel with said arrays (2) of capacitors (21);
wherein said control unit (15) is connected to said regulating means (16) to control their selective activation; and
wherein said generator (2) is a synchronous reluctance generator and comprise a squirrel cage structure (12),
the method comprising the following steps:
a) activating said generator (2) powered by the outer power source (S);
b) detecting by said control unit (15) an output tension (Vi) from said generator (2) and comparing an output tension with an optimum working tension (V2);
c) activating said arrays (2) of capacitors (21) by said control unit (15);
d) connecting said generator (2) to the isolated load (C);
e) detecting an outgoing tension (Vi) outgoing from the generator (2) and comparing the outgoing tension to the optimum working tension (V2) by said control unit (15);
f) activating said tension compensator circuit (22) when the outgoing tension (Vi) is lower than the optimum working tension (V2); and
g) fluxating a capacitive current in said electric circuit (4) by said compensator circuit (22).
